(19) United States
(12) Patent Application Publication
(10) Pub. No.: US 2007/0229726 A1
(43) Pub. Date: Oct. 4, 2007

(54) Liquid crystal display device

(75) Inventors: Yuji Azuma, Mobara (JP); Masaki Tsubokura, Mobara (JP); Shunsuke Morishita, Mobara (JP); Shimon Itakura, Mobara (JP); Seigo Abo, Hitachi (JP)

Correspondence Address: Stanley P. Fisher;Reed Smith LLP, Suite 1400, 3110 Fairview Park Drive, Falls Church, VA, 22042-4503, US

(73) Assignees: Hitachi Displays, Ltd.; Hitachi Display Devices, Ltd.

(21) Appl. No.: 11/729,778

(22) Filed: Mar. 30, 2007

(30) Foreign Application Priority Data
Apr. 4, 2006 (JP) 2006-102861

(51) Int. Cl. G02F 1/1333

(52) U.S. Cl. 349/58

(57) ABSTRACT

In a liquid crystal display device, a support member for supporting a liquid crystal display panel and a reflection member are fixed to a lower frame with screws at different positions respectively thus preventing the deformation of the lower frame of the liquid crystal display device. A liquid crystal display device includes a liquid crystal display panel; a support member which supports an outer peripheral portion of the liquid crystal display panel; a light source and a reflection member which are arranged in a region which is overlapped to a display screen of the liquid crystal display panel; and a frame member which is arranged behind the light source as viewed from the liquid crystal display panel. In such a constitution, the frame member includes a folded portion which is folded toward the liquid crystal display panel side outside a display region of the liquid crystal display panel. The support member is fixed to the frame member with screws in a region between an outer periphery of the first frame member and the folded portion. The reflection member is fixed to the frame member in a region inside the folded portion of the first frame member and a region outside the folded portion.

The present application claims priority from Japanese application JP2006-102861 filed on Apr. 4, 2006, the content of which is hereby incorporated by reference into this application.

### BACKGROUND OF THE INVENTION

### 1. Field of the Invention

The present invention relates to a liquid crystal display device, and more particularly to a technique which is effectively applicable to a liquid crystal display device which arranges a backlight behind a liquid crystal display panel.

Conventionally, a liquid crystal display device has been popularly used in a display device ranging from a large-sized display device such as a display of a television receiver set or a PC (Personal Computer) to a portable electronic equipment such as a mobile phone or a PDA (Personal Digital Assistant).

Further, with respect to the above-mentioned liquid crystal display device, there has been known a liquid crystal display device which arranges a backlight having a light source such as a fluorescent lamp or an LED behind (on a back side of) the liquid crystal display panel. The backlight is classified into, for example, a direct backlight and an edge-type or side-type backlight depending on a manner of radiating light from the light source to the liquid crystal display panel.

In the direct backlight, a light source is arranged in a region where the light source is overlapped to a display region of the liquid crystal display panel in a plan view. For example, a reflector is arranged behind (on a back side of) the light source as viewed from the liquid crystal display panel. In the edge-type backlight, for example, a light guide plate is arranged in a region where the light guide plate is overlapped to a display region of a liquid crystal display device in a plan view, and the light source is arranged on an end portion of the light guide plate.

The direct backlight allows the liquid crystal display device to acquire the high brightness more easily than the edge-type backlight. Accordingly, for example, the liquid crystal display device used as a display of the television receiver set or a PC generally has the direct backlight.

In the liquid crystal display device which has the direct backlight, for example, a display module which is formed by integrally supporting the liquid crystal display panel and the backlight using frame members (support members) which are referred to as a lower frame and an upper frame is housed in an exterior (housing).

Further, along with the increase of a demand for the miniaturization, the reduction of thickness and the narrowing of a picture frame of the exterior in recent years, there have been proposed various constitutions and housing methods of the liquid crystal display module (frame member) for realizing such a demand (see JP-A-2004-29186 (corresponding US application 2003/0234895 A1)).

Here, in the direct backlight used in the conventional liquid crystal display device, for example, a plurality of fluorescent lamps (light source) are arranged at positions where the fluorescent lamps are overlapped to a display region of the liquid crystal display panel in a plan view and, for example, a reflector is arranged behind (on a back side of) the light source as viewed from the liquid crystal display panel. Here, as the reflector, for example, a reflector which is formed by folding a metal plate and increases a reflectance of a surface thereof which faces the liquid crystal display device is generally used.

However, in the recent liquid crystal display device having the direct backlight, for example, there may be a case that a reflection member made of a white resin which is referred to as a side mold is used in place of the reflector which is formed by folding the metal plate. Here, the schematic constitution of the liquid crystal display device which uses the side mold is briefly explained in conjunction with FIG. 10. FIG. 10 is a schematic cross-sectional view showing one example of a conventional liquid crystal display device which uses a side mold.

In the liquid crystal display device (liquid crystal display module) which uses the side mold, for example, as shown in FIG. 10, an outer peripheral portion of a liquid crystal display panel 1 is supported on a support member (middle frame) 2. Further, in a region which is overlapped to a display region of the liquid crystal display panel 1, fluorescent lamps 3 are arranged. Further, in a region which is overlapped to the outer peripheral portion of the liquid crystal display panel 1, a side mold 4 having an inclined surface (reflection surface) 401 which reflects light from the fluorescent lamps 3 thereon and leads the light to the liquid crystal display panel 1 side is arranged. Here, the side mold 4 is arranged annularly so as to surround the fluorescent lamps 3 using one or a plurality of members.

Here, the support member 2 and the side mold 4 are, for example, fixed to the lower frame 5 with screws. The lower frame 5 includes, for example, a first folded portion which is folded to the liquid crystal display panel 1 side outside a first region 501 which is overlapped to the display region of the liquid crystal display panel 1 in a plan view and second folded portion between an outer periphery of the lower frame 5 and the first folded portion. A second region 502 between an outer periphery of the lower frame 5 and the second folded portion extends substantially parallel to a display screen of the liquid crystal display panel 1 and in the direction away from the liquid crystal display panel 1. Here, the side mold 4 is fixed to the first region 501 of the lower frame 5 with screws 6A, while the support member 2 is fixed to the second region 502 of the lower frame 5 with screws 6B.

An outer peripheral portion of the liquid crystal display panel 1 is supported on the support member 2 and an upper frame 7. Here, although not shown in the drawing, the upper frame 7 and the lower frame 5 are fixed to each other with screws, for example. Further, between a surface of the liquid crystal display panel 1 opposite to a display screen and the support member 2 as well as between the display screen of the liquid crystal display panel 1 and the upper frame 7, spacers 8A, 8B are interposed, for example.

Further, between the liquid crystal display panel 1 and the fluorescent lamps 3, an optical sheet such as a diffusion plate 9 is arranged. The diffusion sheet 9 has an outer peripheral portion thereof sandwiched between the support member 2 and the side mold 4, for example. Here, spacers 8C is interposed between the support member 2 and the diffusion plate 9.

### SUMMARY OF THE INVENTION

Here, in the liquid crystal display device (liquid crystal display module) having the constitution shown in FIG. 10, two folded portions are formed between the second region 502 where the support member 2 is fixed to the lower frame 5 with screws and the first region 501 where the side mold 4 is fixed to the lower frame 5 with screws. Accordingly, for example, when the liquid crystal display panel 1 is displaced in the direction parallel to the display screen due to vibrations or an impact and an outer peripheral end surface of the liquid crystal display panel 1 is brought into contact with the support member 2, the support member 2 receives an external force P from the liquid crystal display panel 1.

Here, since the support member 2 is fixed to the second region 502 of the lower frame 5 with screws, the external force P which the support member 2 receives is transmitted also to the second region 502 of the lower frame 5. Accordingly, for example, there exists a drawback that a moment M is generated in the first folded portion of the lower frame 5 and, for example, as shown in FIG. 11, the first folded portion of the lower frame 5 is deformed.

Accordingly, it is an object of the present invention to provide a technique which can prevent the deformation of a lower frame of a liquid crystal display device in which a support member and a reflection member which support the liquid crystal display panel are fixed to the lower frame with screws at positions different from each other.

The above-mentioned and other objects and novel features of the present invention will become apparent by the description of this specification and attached drawings.

To briefly explain the typical inventions among the inventions disclosed in this specification, they are as follows.

(1) The present invention provides a liquid crystal display device which includes: a liquid crystal display panel; a support member which supports an outer peripheral portion of the liquid crystal display panel; a light source and a reflection member which are arranged in a region which is overlapped to a display screen of the liquid crystal display panel in a plan view; a first frame member which is arranged behind the light source as viewed from the liquid crystal display panel; and a second frame member which supports the outer peripheral portion of the liquid crystal display panel together with the support member, wherein the first frame member includes a folded portion which is folded toward the liquid crystal display panel side outside a region which is overlapped to a display region of the liquid crystal display panel in a plan view, the support member is fixed to the first frame member with screws in a region between an outer periphery of the first frame member and the folded portion, and the reflection member is fixed to the frame member with screws in a region inside the folded portion of the first frame member and a region outside the folded portion.

(2) In the liquid crystal display device having the constitution (1), the first frame member includes another folded portion between the outer periphery and the folded portion, and includes a region which extends in the direction substantially parallel to the display screen of the liquid crystal display panel between the outer periphery and another folded portion, and the support member and the reflection member are fixed to the frame member with screws in the region which extends in the direction substantially parallel to the display screen of the liquid crystal display panel between the outer periphery and another folded portion of the first frame member.

(3) In the liquid crystal display device having the constitution (2), the reflection member includes a portion which is interposed between the support member and the region between the outer periphery and another folded portion of the first frame member, and the support member is fixed to the first frame member with screws at a portion where the portion of the reflection member is interposed.

(4) In the liquid crystal display device having any one of the constitutions (1) to (3), the reflection member is constituted of one or a plurality of members which are arranged annularly on an outer peripheral portion of the first frame member.

(5) In the liquid crystal display device having any one of the constitutions (1) to (4), the first frame member passes through the folded portion and extends to a region inside the folded portion from a region outside the folded portion, and a projecting portion or a groove portion is formed in a projecting manner or in a recessed manner on a surface of the first frame member opposite to a surface of the first frame member which faces the liquid crystal display panel.

(6) In the liquid crystal display device having the constitution (5), the projecting portions or the groove portions has a length of a portion thereof inside the folded portion set larger than a length of a portion thereof outside the folded portion.

The liquid crystal display device of the present invention is made on a premise that the support member and the reflection member which support the liquid crystal display device are fixed with screws to the first frame member which is arranged behind the reflection member as viewed from the liquid crystal display panel. Here, the first frame member includes one or more folded portions outside a display region of the liquid crystal display panel, and the support member is fixed with screws to the first frame member in the region between the outer periphery of the first frame member and one folded portion out of the above-mentioned one or more folded portions. Further, the reflection member is fixed to the first frame member with screws in the region outside the folded portion and the region inside the folded portion. Due to such a constitution, when the support member receives an external force, a moment which is generated in the folded portion of the first frame member can be set to a small value thus preventing the deformation of the folded portion.

Here, in the first frame member, it is preferable to provide another folded portion between the outer periphery and the folded portion and to provide a region which extends in the direction substantially parallel to the display screen of the liquid crystal display panel between the outer periphery and another folded portion. Further, it is preferable that the support portion and the reflection member are fixed to the frame member with screws in the region which extends in the direction substantially parallel to the display screen of the liquid crystal display panel between the outer periphery and another folded portion of the first frame member. Due to such a constitution, the operability of fixing the reflection member with screws and the operability of fixing the support member with the screws can be enhanced.

Further, the support member is usually formed in an annular shape which surrounds the outer peripheral portion of the liquid crystal display panel and hence, the reflection member includes a portion which is interposed between the support member and the region between the outer periphery and another folded portion of the first frame member. Accordingly, it is preferable that the support member is fixed to the first frame member with screws at a portion where the portion of the reflection member is interposed. Due to such a constitution, the portions of the reflection member which are fixed to the outer periphery of the first frame member and another folded portion can be collectively fixed with screws together with the support member. Accordingly, the number of screw fixing operations can be reduced thus enhancing the operability of the screw fixing operation and, at the same time, the number of screws which are used for the screw fixing operation can be reduced.

Further, it is preferable that the reflection member is constituted of one or a plurality of members which are referred to as side molds and are arranged annularly. The side mold is, for example, a white resin molded member and hence there is no possibility that a reflection surface lacks in the portion where the screw fixing is performed at the time of performing the fixing outside the reflection surface with screws. Accordingly, it is possible to reduce reflection irregularities.

Further, in the liquid crystal display device of the present invention, the first frame member may preferably configured such that the first frame member passes through the folded portion and extends to the region inside the folded portion from a region outside the folded portion, and the projecting portions or the groove portions are formed in a projecting manner on the surface of the first frame member opposite to the surface of the first frame member which faces the liquid crystal display panel at a plurality of portions. The projecting portion or the groove portion is a member which is usually referred to as a rib. By providing the ribs on two sides (surfaces) of the first frame member which sandwich the folded portion, the folded portion is hardly deformed. Accordingly, it is possible to prevent the deformation of the folded portion due to the moment which is generated in the folded portion.

Further, here, when the projecting portions or the groove portions has a length of a portion thereof inside the folded portions set larger than a length of a portion thereof outside the folded portion, an effect of preventing the deformation of the folded portion is improved.

### BRIEF DESCRIPTION OF THE DRAWINGS

FIG. 1 is a schematic plan view showing the schematic constitution of a liquid crystal display device of one embodiment according to the present invention;

FIG. 2 is an enlarged plan view of a region AR1 in FIG. 1;

FIG. 3 is a schematic cross-sectional view taken along a line A-A′ in FIG. 2;

FIG. 4 is a cross-sectional view taken along a line B-B′ in FIG. 2;

FIG. 5 is a schematic cross-sectional view for explaining the manner of operation of the liquid crystal display device of this embodiment;

FIG. 6 is a schematic plan view for explaining a first modification of the liquid crystal display device of this embodiment;

FIG. 7 is a schematic plan view for explaining a second modification of the liquid crystal display device of this embodiment;

FIG. 8 is a schematic cross-sectional view for explaining an example to which the liquid crystal display device of the embodiment is applied;

FIG. 9 is a cross-sectional view taken along a line C-C′ in FIG. 8;

FIG. 10 is a schematic cross-sectional view showing one constitutional example of a conventional liquid crystal display device using side molds; and

FIG. 11 is a schematic view for explaining drawbacks of the liquid crystal display device shown in FIG. 10.

### DESCRIPTION OF THE PREFERRED EMBODIMENTS

Hereinafter, embodiments of the present invention are explained in detail in conjunction with drawings.

Here, in all drawings for explaining the embodiments, parts having identical functions are given same numerals and their repeated explanation is omitted.

### Embodiment

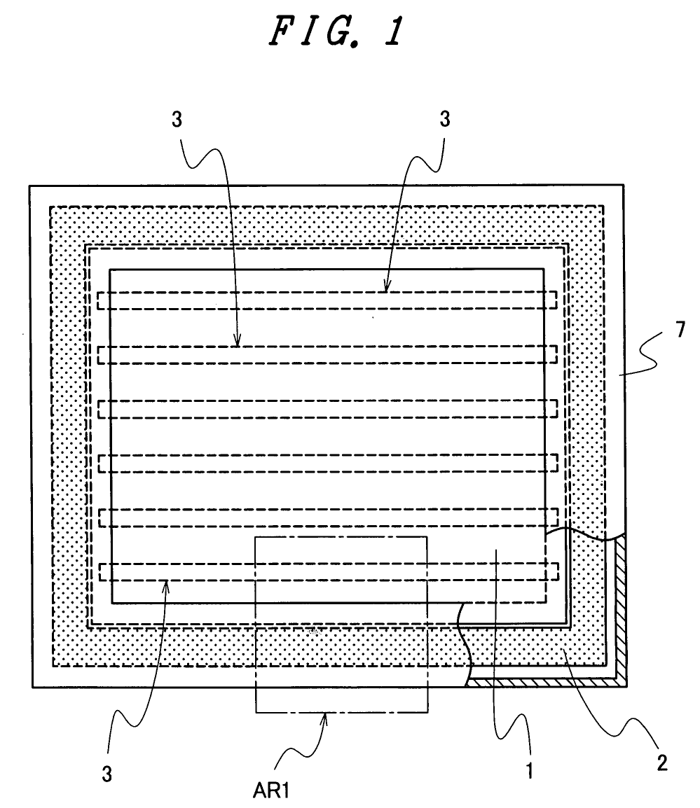

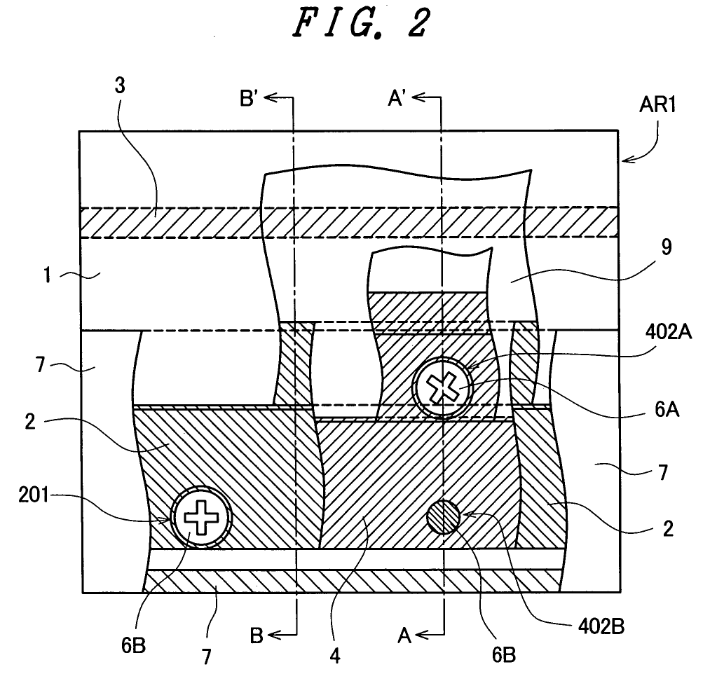

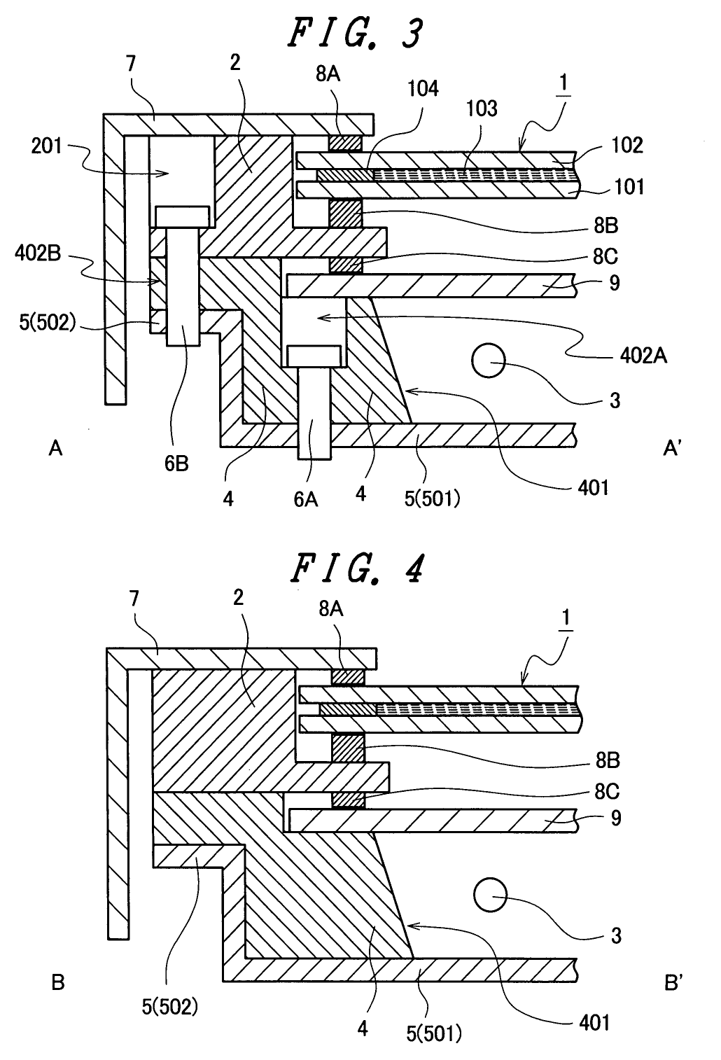

FIG. 1 is a schematic plan view showing the schematic constitution of a liquid crystal display device of one embodiment according to the present invention. FIG. 2 is an enlarged plan view of a region AR1 in FIG. 1. FIG. 3 is a schematic cross-sectional view taken along a line A-A′ in FIG. 2. FIG. 4 is a cross-sectional view taken along a line B-B′ in FIG. 2.

Here, in FIG. 1 which is the plan view, to facilitate the understanding of the constitution of the inside of the liquid crystal display device, an upper frame is partially omitted. Further, in FIG. 2 which is the plan view, to facilitate the understanding of the constitution of the inside of the liquid crystal display device, the upper frame, a support member, a liquid crystal display panel and a diffusion plate are partially omitted.

In the liquid crystal display device of this embodiment, for example, as shown in FIG. 1 to FIG. 4, an outer peripheral portion of the liquid crystal display panel 1 is supported on the support member (middle frame) 2. The support member 2 is formed, for example, by molding using a resin as a material and supports an outer peripheral end surface of the liquid crystal display panel 1 and a back surface side of a display screen.

The liquid crystal display panel 1 is a display panel which includes a first substrate 101 which is referred to as a TFT substrate, and a second substrate 102 which is referred to as a counter substrate, and a liquid crystal material 103 which is sandwiched between the first substrate 101 and the second substrate 102. Here, the first substrate 101 and the second substrate 102 are adhered to each other using an annular sealing material 104, and the liquid crystal material 103 is sealed in a space surrounded by the first substrate 101, the second substrate 102 and the sealing material 104. Here, the constitution of the first substrate 101 and the second substrate 102, a kind of liquid crystal material 103 and the like may be equal to the corresponding constitution, material and the like of a conventional liquid crystal display panel and hence, their detailed explanation is omitted.

Further, in a region which is overlapped to a display region of the liquid crystal display panel 1, fluorescent lamps 3 (light source) are arranged. Further, in a region which is overlapped to an outer peripheral portion of the liquid crystal display panel 1, a side mold 4 having an inclined surface (reflection surface) 401 which reflects light from the fluorescent lamps 3 thereon and leads the light to the liquid crystal display panel 1 side is arranged. Here, the side mold 4 is arranged annularly so as to surround the fluorescent lamps 3 using one or a plurality of members.

Here, the support member 2 and the side mold 4 are, for example, fixed to a lower frame 5 with screws. The lower frame 5 includes, for example, a first folded portion which is folded toward the liquid crystal display panel 1 side outside a first region 501 which is overlapped to the display region of the liquid crystal display panel 1 in a plan view, and a second folded portion between an outer periphery of the lower frame 5 and the first folded portion. Further, a second region 502 between an outer periphery of the lower frame 5 and the second folded portion extends substantially parallel to the display screen of the liquid crystal display panel 1 and in the direction away from the liquid crystal display panel 1. Here, first holes 402A for screw fixing are formed in the side mold 4, and the side mold 4 is fixed to the first region 501 of the lower frame 5 with screws 6A. Further, holes 201 for screw fixing are also formed in the support member 2 and the support member 2 is fixed to the second region 502 of the lower frame 5 with screws 6B.

Here, in the liquid crystal display device of this embodiment, the side mold 4 includes a portion which is interposed between the second region 502 of the lower frame 5 and the support member 2. Here, a portion which is interposed between the second region 502 of the lower frame 5 and the support member 2 is also interposed at a portion where the support member 2 is fixed with the screws, and a second holes 402B for screw fixing are formed in the support member 2 at positions which are overlapped to the holes 201 for screw fixing. Accordingly, the side mold 4 is fixed to the first region 501 of the lower frame 5 with the screws 6A, and is fixed to the second region 502 of the lower frame 5 with the screw 6B for screw fixing the support member 2.

The outer peripheral portion of the liquid crystal display panel 1 is supported on the support member 2 and the upper frame 7. Here, although not shown in the drawing, the upper frame 7 and the lower frame 5 are fixed to each other with screws, for example. Here, between the display screen of the liquid crystal display panel 1 and the upper frame 7 as well as between a back surface of the display screen of the liquid crystal display panel 1 and the support member 2, for example, spacers 8A, 8B are interposed.

Further, between the liquid crystal display panel 1 and the fluorescent lamps 3, an optical sheet such as a diffusion plate 9 is arranged. The diffusion plate 9 is, for example, supported such that an outer peripheral portion thereof is sandwiched by the support member 2 and the side mold 4. Here, between the support member 2 and the diffusion plate 9, for example, spacers 8C are interposed.

Here, the liquid crystal display device of this embodiment is characterized with the screw fixing constitution of the support member 2 and the lower frame 5 and the screw fixing constitution of the side mold 4 and the lower frame 5. Since other constitutions of the liquid crystal display device are equal to the corresponding constitution of the conventional liquid crystal display device, the detailed explanation of other constitution is omitted.

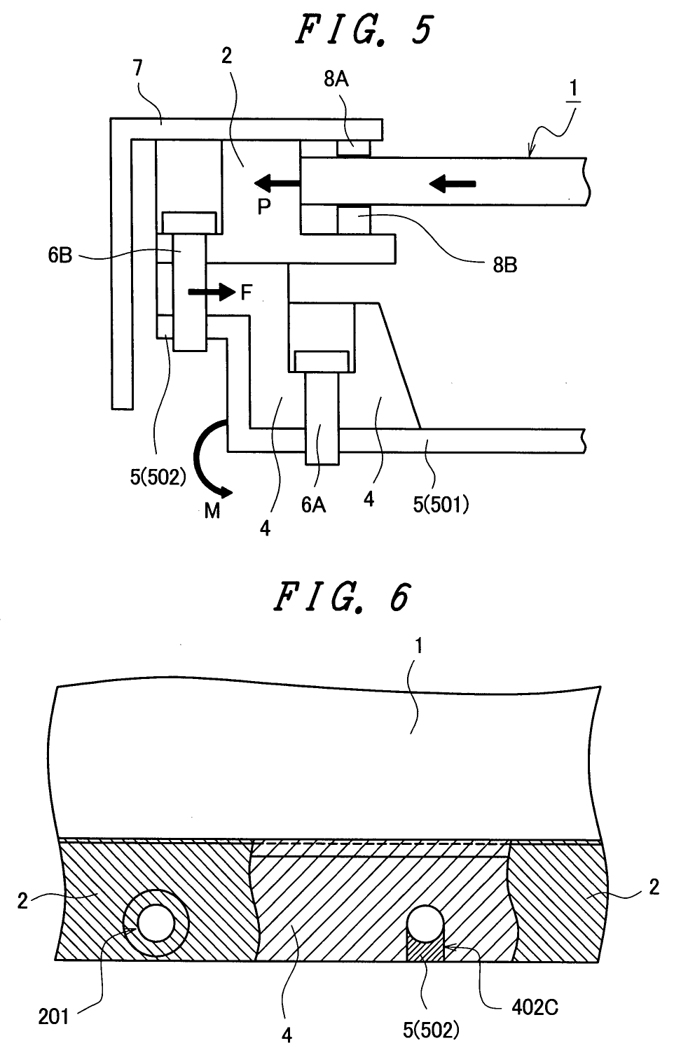

FIG. 5 is a schematic cross-sectional view for explaining the manner of operation and advantageous effects of the liquid crystal display device of this embodiment.

Here, FIG. 5 shows a cross section taken along a line A-A′ in FIG. 2 and omits portions of the liquid crystal display device unnecessary for the explanation of the manner of operation and the advantageous effects. Further, in FIG. 5, to facilitate the understanding of the manner of operation and the advantageous effects, hatching (parallel oblique lines) which indicate the cross section is omitted.

In the liquid crystal display device of this embodiment, the liquid crystal display panel 1 is supported on the support member 2 and the upper frame 7 in a state that the outer peripheral portion of the liquid crystal display panel 1 is sandwiched by the support member 2 and the upper frame 7. Here, the display screen and the back surface of the liquid crystal display panel 1 are, for example, sandwiched by spacers 8A which are adhered to the upper frame 7 and spacers 8B which are adhered to the support member 2. However, clearances are respectively formed between the outer peripheral end surface of the liquid crystal display panel 1 and the support member 2, between the display screen of the liquid crystal display panel 1 and the spacers 8A, and between the back surface of the display screen of the liquid crystal display panel 1 and the spacers 8B. Accordingly, for example, as shown in FIG. 5, the liquid crystal display panel 1 may be displaced in the direction parallel to the display screen due to vibrations, an impact or the like thus bringing the outer peripheral end surface of the liquid crystal display panel 1 into contact with the support member 2. In this case, the support member 2 receives an external force P from the outer peripheral end surface of the liquid crystal display panel 1.

When the support member 2 receives the external force P from the outer peripheral end surface of the liquid crystal display panel 1, the external force P is also transmitted to the lower frame 5 to which the support member 2 is fixed with the screws 6B. Here, according to the display device of this embodiment, the side mold 4 is interposed at a portion (second region 502) where the support member 2 is fixed to the lower frame 5 with the screws. Further, the side mold 4 is fixed to the lower frame 5 at another portion (first region 501) with the screws. Accordingly, in the second region 502 of the lower frame 5, for example, on a surface along which the support member 2 and the side mold 4 are brought into contact with each other, the support member 2 generates a resistance force in the direction opposite to the external force P from the outer peripheral end surface of the liquid crystal display panel 1. Further, the screws 6B for screw fixing the support member 2 receive a force in the direction opposite to the external force P from the outer peripheral end surface of the liquid crystal display panel 1 from side surfaces of the second holes 402b for screw fixing of the side mold 4. That is, by interposing the side mold 4 between the second region 502 of the lower frame 5 and the support member 2, and by fixing the lower frame 5 and the side mold 4 with the screws, a force F in the direction opposite to the external force P from the outer peripheral end surface of the liquid crystal display panel 1 is generated in the support member 2. As a result, a moment M which is generated on the first folded portion of the lower frame 5 can be reduced thus preventing the deformation of the first folded portion of the lower frame 5.

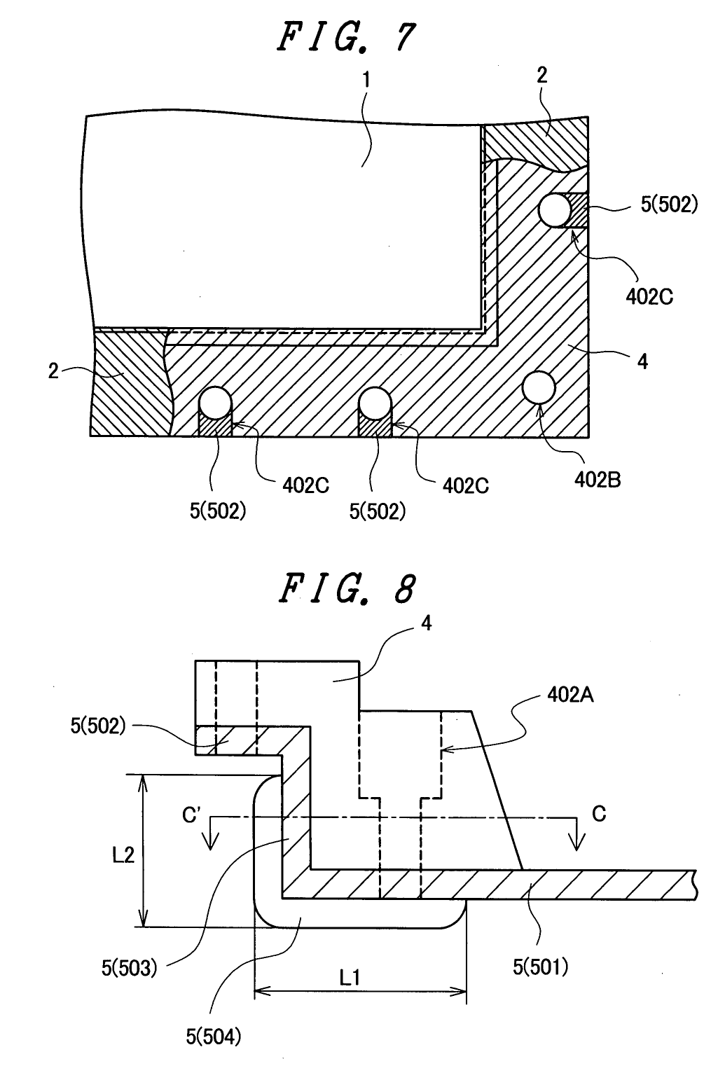

FIG. 6 is a schematic plan view for explaining a first modification of the liquid crystal display device of this embodiment. Further, FIG. 7 is a schematic plan view for explaining a second modification of the liquid crystal display device of this embodiment.

Here, FIG. 6 is an enlarged plan view of a portion of the outer peripheral portion of the liquid crystal display device (liquid crystal display module). In the drawing, the upper frame is omitted and the support member 2 is also partially omitted. Further, FIG. 7 is an enlarged plan view of one corner portion of the outer peripheral portion of the liquid crystal display device (liquid crystal display module). In the drawings, the upper frame is omitted and the support member 2 is also partially omitted.

In the liquid crystal display device of this embodiment, as shown in FIG. 2 and FIG. 3, the side mold 4 which is fixed to the lower frame 5 with the screws in the first region 501 of the lower frame 5 is also interposed at the position where the second region 502 of the lower frame 5 and the support member 2 are fixed with screws. Further, by forming second holes 402B for screw fixing in the side mold 4 and by fixing the support member 2 and the side mold 4 to the second region 502 of the lower frame 5 with screws, the deformation of the first molded portion of the lower frame 5 can be prevented.

Here, the second holes 402B for screw fixing which are formed in the side mold 4 at the portion where the second region 502 of the lower frame 5 and the support member 2 are fixed with screws are formed of a one-side open hole 402C which allows a portion of a side surface thereof to reach an end surface of the side mold thus opening the hole, as shown in FIG. 6.

Further, the second holes 402B for screw fixing which are formed in the side mold 4 at the portions where the second region 502 of the lower frame 5 and the support member 2 are fixed with the screws, for example, as shown in FIG. 7, may be formed such that the holes which are formed in a middle portion of each side of the display panel are formed of a one-side opened holes 402C, and holes 402B which have side surfaces thereof closed (not opened) are formed in the portions having a wide width such as corner portions.

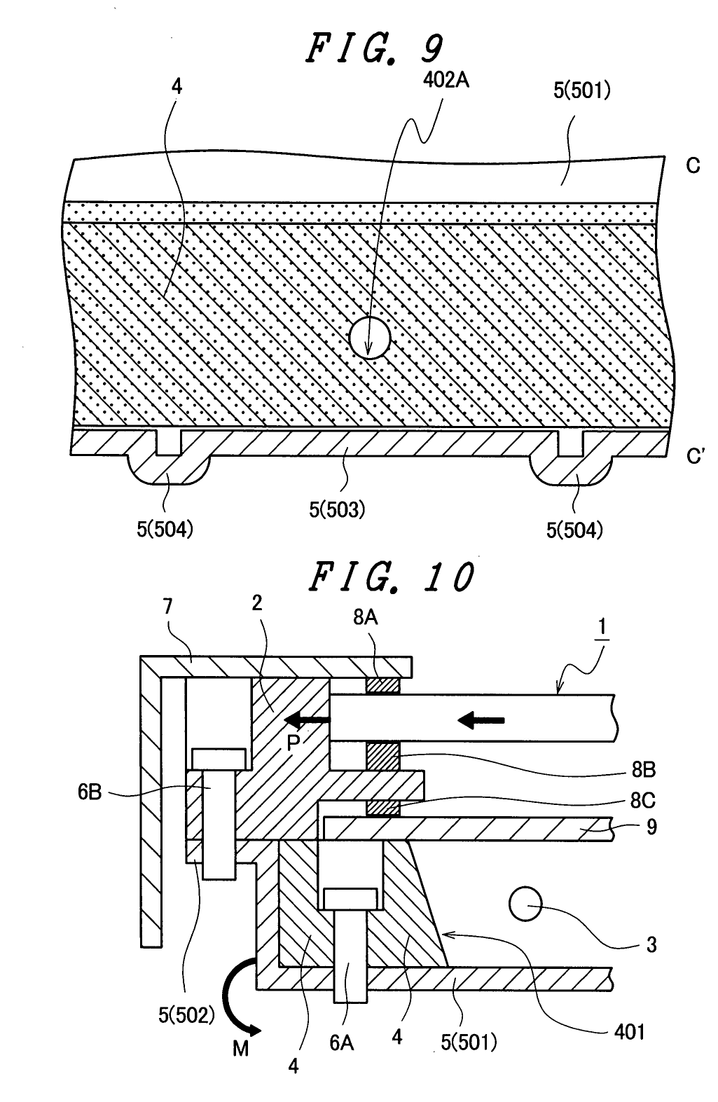

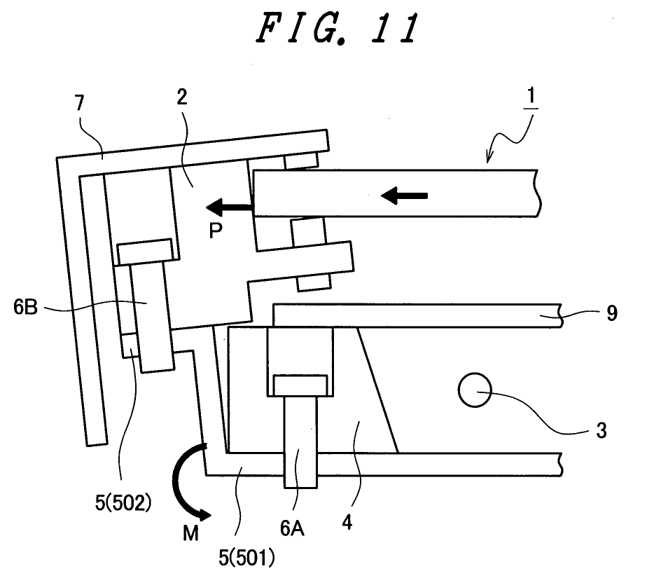

FIG. 8 is a schematic cross-sectional view for explaining an example to which the liquid crystal display device of the embodiment is applied. Further, FIG. 9 is a cross-sectional view taken along a line C-C′ in FIG. 8.

Here, FIG. 8 shows only the constitution of the lower frame 5 and the side mold 4 in the cross section taken along a line B-B′ in FIG. 2. Further, FIG. 8 omits hatching of the side mold 4.

In the liquid crystal display device of this embodiment, the side mold 4 is interposed between the second region 502 of the lower frame 5 and the support member 2, and the support member 2 and the side mold 4 are fixed to the second region 502 of the lower frame 5 with screws thus preventing the deformation of the first folded portion of the lower frame 5.

Here, for example, as shown in FIG. 8 and FIG. 9, on two sides (surfaces) which are connected at the first folded portion of the lower frame 5, that is, on the first region 501 of the lower frame 5 and a third region 503 which connects the first region 501 and the second region 502, ribs (projecting portions) 504 which extend over the first region 501 and the third region 503 may be formed. The ribs 504 are projections or groove portions which are formed on a back surface side of the lower frame 5 opposite to a surface of the lower frame 5 which faces the liquid crystal display panel 1 and are formed by drawing or press forming, for example. By providing such ribs 504 to the lower frame 5, the first folded portion of the lower frame 5 is hardly deformed thus increasing an advantageous effect of preventing the deformation of the first folded portion attributed to the moment M.

Here, assuming a length of the ribs 504 on the first region 501 side of the lower frame 5 as L1 (mm) and a length of the ribs 504 on the third region 503 side of the lower frame 5 as L2 (mm), by forming the ribs 504 such that the relationship of L1>L2 is established, it is possible to further effectively prevent the deformation of the first folded portion of the lower frame 5.

Although the present invention has been specifically explained in conjunction with the embodiment heretofore, it is needless to say that the present invention is not limited to the above-mentioned embodiment and various modifications are conceivable without departing from the gist of the present invention.

What is claimed is:

1. A liquid crystal display device comprising:
a liquid crystal display panel;
a support member which supports an outer peripheral portion of the liquid crystal display panel;
a light source and a reflection member which are arranged in a region which is overlapped to a display screen of the liquid crystal display panel in a plan view;
a first frame member which is arranged behind the light source as viewed from the liquid crystal display panel; and
a second frame member which supports the outer peripheral portion of the liquid crystal display panel together with the support member, wherein
the first frame member includes a folded portion which is folded toward the liquid crystal display panel side outside a region which is overlapped to a display region of the liquid crystal display panel in a plan view,
the support member is fixed to the first frame member with screws in a region between an outer periphery of the first frame member and the folded portion, and
the reflection member is fixed to the frame member with screws in a region inside the folded portion of the first frame member and a region outside the folded portion.

2. A liquid crystal display device according to claim 1, wherein the first frame member includes another folded portion between the outer periphery and the folded portion, and includes a region which extends in the direction substantially parallel to the display screen of the liquid crystal display panel between the outer periphery and another folded portion, and
the support member and the reflection member are fixed to the frame member with screws in the region which extends in the direction substantially parallel to the display screen of the liquid crystal display panel between the outer periphery and another folded portion of the first frame member.

3. A liquid crystal display device according to claim 2, wherein the reflection member includes a portion which is interposed between the support member and the region between the outer periphery and another folded portion of the first frame member, and
the support member is fixed to the first frame member with screws at a portion where the portion of the reflection member is interposed.

4. A liquid crystal display device according to claim 1, wherein the reflection member is constituted of one or a plurality of members which are arranged annularly on an outer peripheral portion of the first frame member.

5. A liquid crystal display device according to claim 1, wherein the first frame member passes through the folded portion and extends to a region inside the folded portion from a region outside the folded portion, and a projecting portion or a groove portion is formed in a projecting manner or in a recessed manner on a surface of the first frame member opposite to a surface of the first frame member which faces the liquid crystal display panel.

6. A liquid crystal display device according to claim 5, wherein the projecting portions or the groove portions has a length of a portion thereof inside the folded portion set larger than a length of a portion thereof outside the folded portion.
